(19) United States
(12) Patent Application Publication
(10) Pub. No.: US 2013/0099475 A1
(43) Pub. Date: Apr. 25, 2013

(54) LIGHT WEIGHT Z-SWIVEL

(71) Applicants: James M. Dalton, Elk River, MN (US); Matt Jungklaus, Lawrenceville, GA (US); David J. Castagnetta, Maple Grove, MN (US); Christopher A. Lins, Crystal, MN (US)

(72) Inventors: James M. Dalton, Elk River, MN (US); Matt Jungklaus, Lawrenceville, GA (US); David J. Castagnetta, Maple Grove, MN (US); Christopher A. Lins, Crystal, MN (US)

(21) Appl. No.: 13/635,786

(22) PCT Filed: Mar. 17, 2011
(86) PCT No.: PCT/US11/28753

§ 371 Date: Sep. 18, 2012

Related U.S. Application Data
(60) Provisional application No. 61/315,291, filed on Mar. 18, 2010.

(51) Int. Cl. F16L 27/08

(52) U.S. Cl. CPC F16L 27/08
USPC 285/121.3

(57) ABSTRACT

Z-swivel 10 is comprised of a female coupling 12 designed to attach to a hose 30 (or application device 32) and in turn is attached to an inlet stud 14 which is rotatably located in seal housing 16. Seals 18 and 20 seal and allow rotation between stud 14 and seal housing 16. Similarly, seal housing 16 contains seals 34 which allow rotation of seal housing 16 relative to center stud 22. Outlet coupling 24 is rotatably attached to center stud 22 with seals 28 and retained in place by retaining ring 26. Pipe plug 36 seals the end of center stud 22. Passages 38, 42, 40, 46 and 44 connect in that order to allow flow of fluid including thick and viscous fluids such as drywall mud through the swivel.

### TECHNICAL FIELD

This application claims the benefit of U.S. Application Ser. No. 61/315,291, filed Mar. 18, 2010, the contents of which are hereby incorporated by reference.

### BACKGROUND ART

Z-swivels are in general well known to allow hose twisting.

### DISCLOSURE OF THE INVENTION

It is an object of this invention to develop a Z-swivel that is lightweight, high flow, high pressure, and capable of being used on drywall joint finishing.

The system uses a z-swivel constructed out of aluminum. The z-swivel has the ability to rotate four parts on three independent axes. The swivel allows for the flow of media and is sealed to the external environment. The z-swivel in used between a hose and an application tool and allows them to move freely without hose twist which causes additional forces for the operator to contend with.

The z-swivel is used to eliminate twist of a hose at the application end of a drywall mud application system which may operate at pressures of up to 2500 psi. The use of a z-swivel also allows the hose to be oriented differently thereby reducing the overall length of the applicator for use in spaces with tight clearances. The use of aluminum reduces weight for ease of usage.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is an isometric view of the Z-swivel of the instant invention.

FIG. 2 is a side view of the Z-swivel of the instant invention.

FIG. 3 is a cross-sectional view of the Z-swivel of the instant invention.

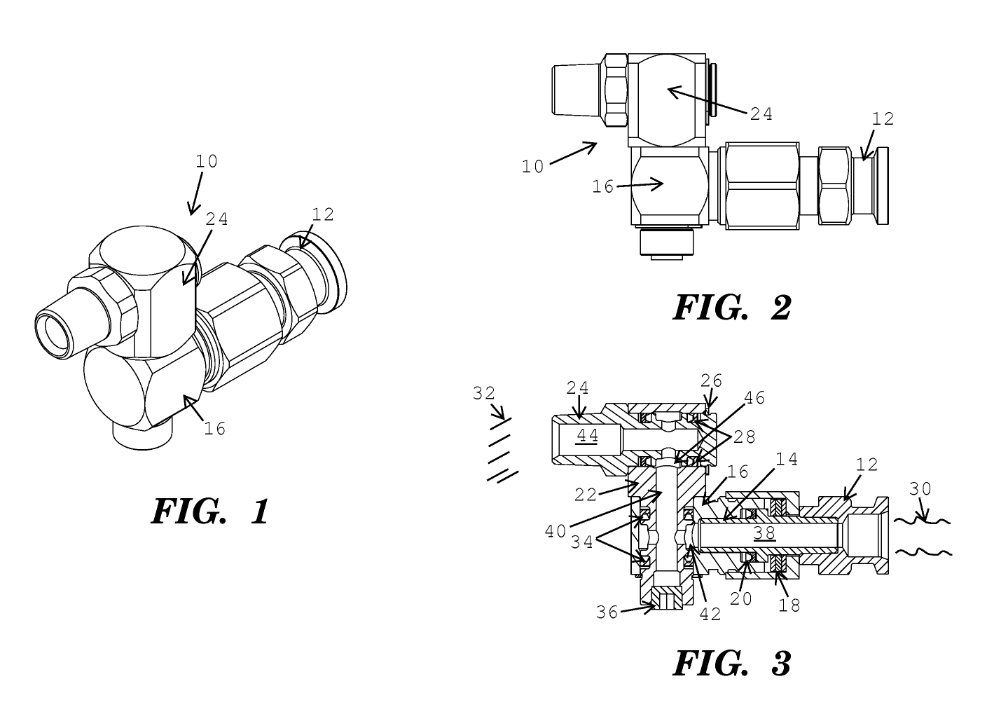

### BEST MODE FOR CARRYING OUT THE INVENTION

The system uses a z-swivel 10 constructed out of aluminum. The z-swivel 10 has the ability to rotate four parts (12, 16, 22 and 24) on three independent axes. The swivel allows for the flow of media and is sealed to the external environment. The z-swivel 10 is used between a hose 30 and an application tool 32 and allows them to move freely without hose twist which causes additional forces for the operator to contend with.

Z-swivel 10 is comprised of a female coupling 12 designed to attach to a hose 30 (or application device 32) and in turn is attached to an inlet stud 14 which is rotatably located in seal housing 16. Seals 18 and 20 seal and allow rotation between stud 14 and seal housing 16. Similarly, seal housing 16 contains seals 34 which allow rotation of seal housing 16 relative to center stud 22. Outlet coupling 24 is rotatably attached to center stud 22 with seals 28 and retained in place by retaining ring 26. Pipe plug 36 seals the end of center stud 22. Passages 38, 42, 40, 46 and 44 connect in that order to allow flow of fluid including thick and viscous fluids such as drywall mud through the swivel.

It is contemplated that various changes and modifications may be made to the swivel without departing from the spirit and scope of the invention as defined by the following claims.

1. A z-swivel for use in transporting pressurized viscous materials, said z-swivel comprising:
a first coupling for attachment to a hose or application device having a fluid passage therethrough;
a seal housing having a fluid passage therethrough;
an inlet stud rotatably located in said seal housing 16 about a first axis of rotation and having a fluid passage therethrough;
a center stud having a fluid passage therethrough, said center stud being rotatable in said fluid housing about a second axis of rotation, said second axis being perpendicular to said first axis; and
an outlet coupling having a fluid passage therethrough and being rotatably attached to center stud along a third axis of rotation, said fluid passages being serially connected.
